(19) United States
(12) Patent Application Publication
(10) Pub. No.: US 2015/0188417 A1
(43) Pub. Date: Jul. 2, 2015

(54) CONTROL APPARATUS APPLIED TO DIGITAL POWER SUPPLY DEVICE, AND DIGITAL POWER SUPPLY DEVICE

(71) Applicant: HUAWEI TECHNOLOGIES CO., LTD., Shenzhen (CN)

(72) Inventors: Zhaozheng HOU, Shenzhen (CN); Ying Li, Xi'an (CN)

(73) Assignee: HUAWEI TECHNOLOGIES CO., LTD., Shenzhen (CN)

(21) Appl. No.: 14/586,088

(22) Filed: Dec. 30, 2014

Related U.S. Application Data
(63) Continuation of application No. PCT/CN2014/081619, filed on Jul. 4, 2014.

(30) Foreign Application Priority Data
Dec. 27, 2013 (CN) 201310740227.5

(51) Int. Cl. H02M 3/04

(52) U.S. Cl. CPC H02M 3/04

(57) ABSTRACT

The present invention discloses a control apparatus applied to a digital power supply device, and a digital power supply device, and pertains to the digital power field. The control apparatus includes: an operational amplifier, an analog to digital converter, a feedback digital filter, a digital pulse-width modulator, a power-level circuit, a feedforward digital filter, and a feedback network. A feedforward function is achieved by configuring a feedforward digital filter, which reduces the number of tables that are used to implement a reciprocal curve, and avoids problems of a long operational delay, a huge resource waste, and a poor feedforward effect.

### CROSS-REFERENCE TO RELATED APPLICATION

This application is a continuation of International Application No. PCT/CN2014/081619, filed on Jul. 4, 2014 , which claims priority to Chinese Patent

Application No. 201310740227.5, filed on Dec. 27, 2013, both of which are hereby incorporated by reference in their entireties.

### TECHNICAL FIELD

The present invention relates to the field of communications technologies, and in particular, to a control apparatus applied to a digital power supply.

### BACKGROUND

At present, as a regulator system, a power source that is used to output constant voltage usually encounters input disturbance and output disturbance. To stabilize output voltage, the disturbance needs to be suppressed, especially in scenarios with an input surge, transient voltage dips, and a relatively high dynamic change rate of load.

The input disturbance is generally solved by means of feedforward; and load disturbance is generally solved by reducing output impedance by means of adding output capacitance or increasing bandwidth of a dynamic system, or by reducing dynamic output impedance by means of nonlinear control, where the bandwidth of a dynamic system can be increased through a nonlinear gain. In the field of communications power, intermediate buses, intermediate bus converters, and point of load (Point of Load) power sources all tend to be digitized. A digital power controller needs to cope with both load disturbance and input disturbance, which imposes a higher requirement on implementation of the digital power controller. At present, a commonly used Buck-type converter (buck converter) of a digital power controller needs to cancel out output disturbance caused by a change of Vin (voltage input end, Input voltage) by using a reciprocal of a value of the Vin.

However, this method of fitting a reciprocal curve has problems of a long operational delay, a huge resource waste, and a poor feedforward effect.

### SUMMARY

A purpose of embodiments of the present invention is to provide a control apparatus applied to a digital power supply device, and a digital power supply device, which can solve problems of a long operational delay, a huge resource waste, and a poor feedforward effect that exist because at present, a reciprocal of Vin is used in a digital power controller to cancel out output disturbance of the Vin.

According to a first aspect, an embodiment of the present invention provides a control apparatus, and the control apparatus includes: an operational amplifier, an analog to digital converter, a feedback digital filter, a digital pulse-width modulator, a power-level circuit, a feedforward digital filter, and a feedback network, where:

an input end of the operational amplifier is a reference voltage input end, and an output end of the operational amplifier is connected to the analog to digital converter, the feedback digital filter, the digital pulse-width modulator, and the power-level circuit in sequence;

a first output end of the power-level circuit is connected back to the input end of the operational amplifier through the feedback network, and a second output end of the power-level circuit generates an output directly; and

an input end of the feedforward digital filter is a voltage input end, and an output end of the feedforward digital filter is connected to an input end of the digital pulse-width modulator.

With reference to the first aspect, in a first implementation manner of the first aspect, the feedforward digital filter includes:

a digital signal input end, a first path, a second path, a digital signal output end, and two nonlinear gain units, where:

the digital signal input end is connected to an input end of the first path, and an output end of the first path is connected to the digital signal output end;

the digital signal input end is connected to an input end of the two nonlinear gain units, an output end of one nonlinear gain unit of the two nonlinear gain units is connected to the first path, and an output end of the other nonlinear gain unit is connected to the second path; and

an output end of the second path is connected to the digital signal output end.

With reference to the first implementation manner of the first aspect, in a second implementation manner of the first aspect, the first path is a proportional element P path; and

the second path is an integral element I path.

With reference to the first aspect, the first implementation manner of the first aspect, or the second implementation manner of the first aspect, in a third implementation manner of the first aspect, the feedback digital filter includes:

a digital signal input end, a third path, a fourth path, a fifth path, a digital signal output end, and at least one nonlinear gain unit, where:

the digital signal input end is connected to the digital signal output end through the third path, the fourth path, and the fifth path separately; and

an input end of the nonlinear gain unit is connected to the digital signal input end, and an output end of the nonlinear gain unit is connected to the third path, the fourth path, and the fifth path separately, where each nonlinear gain unit is corresponding to one path.

With reference to the third implementation manner of the first aspect, in a fourth implementation manner of the first aspect, the third path is a proportional element P path;

the fourth path is an integral element I path; and

the fifth path is a differential element D path.

With reference to the third implementation manner first aspect or the fourth implementation manner of the first aspect, in a fifth implementation manner of the first aspect, the number of nonlinear gain unit is corresponding to the number of paths; and an output end of each nonlinear gain unit is correspondingly connected to one path.

According to a second aspect, an embodiment of the present invention provides a digital power supply device, where the foregoing control apparatus is used as a main control apparatus of the digital power supply unit.

Beneficial effects of the present invention are as follows: A feedforward function is achieved by configuring a feedforward digital filter, which reduces tables that are used to implement a reciprocal curve, avoids problems of a long operational delay, a huge resource waste, and a poor feedforward effect; and embraces a favorable application prospect.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of a control apparatus according to an embodiment of the present invention;

FIG. 2 is a schematic diagram of a feedforward digital filter of a control apparatus according to an embodiment of the present invention;

FIG. 3 is a schematic diagram of a feedback digital filter of a control apparatus according to an embodiment of the present invention; and

FIG. 4 is a schematic diagram of a digital power supply device according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

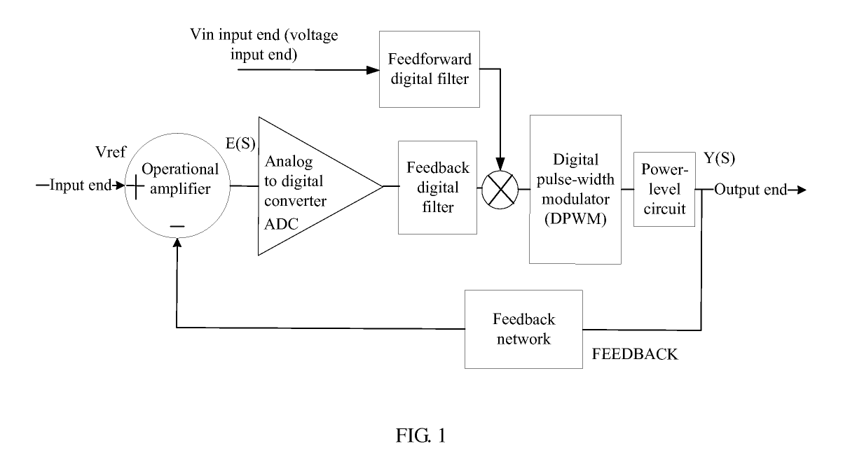

FIG. 1 shows a control apparatus according to Embodiment 1 of the present invention. The control apparatus includes: an operational amplifier, an analog to digital converter, a feedback digital filter, a digital pulse-width modulator, a power-level circuit, a feedforward digital filter, and a feedback network, where

an input end of the operational amplifier is a reference voltage input end, and an output end of the operational amplifier is connected to an input end of the analog to digital converter;

an output end of the analog to digital converter is connected to an input end of the feedback digital filter;

an output end of the feedback digital filter is connected to an input end of the digital pulse-width modulator;

an output end of the digital pulse-width modulator is connected to an input end of the power-level circuit;

a first output end of the power-level circuit is connected back to the input end of the operational amplifier through the feedback network, and a second output end of the power-level circuit generates an output directly; and

an input end of the feedforward digital filter is a voltage input end (Vin input end), and an output end of the feedforward digital filter is connected to the input end of the digital pulse-width modulator.

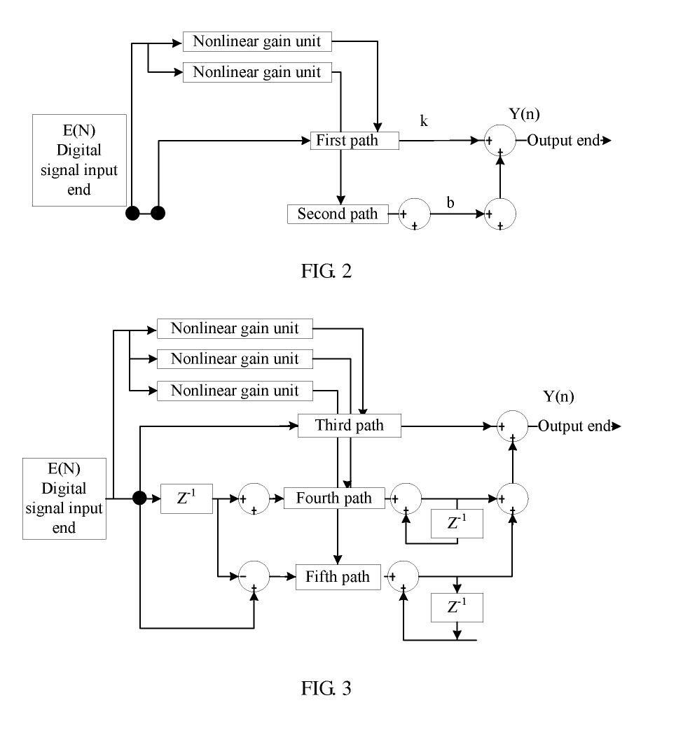

FIG. 2 shows the feedforward digital filter in the foregoing control apparatus, where the feedforward digital filter includes: a digital signal input end, a first path, a second path, a digital signal output end, and two nonlinear gain units (as shown in FIG. 2, the two nonlinear gain units may be a first nonlinear gain unit and a second nonlinear gain unit from top to bottom), where

the digital signal input end is connected to an input end of the first path, and an output end of the first path is connected to the digital signal output end;

the digital signal input end is connected to an input end of the two nonlinear gain units, an output end of one nonlinear gain unit of the two nonlinear gain units is connected to the first path, and an output end of the other nonlinear gain unit is connected to the second path; and

an output end of the second path is connected to the digital signal output end.

The first path in the foregoing feedforward digital filter may be a proportional element P path, and the second path may be an integral element I path.

In the control apparatus shown in FIG. 1, E(N) generally refers to an error signal, and is an input of the two nonlinear gain units. Outputs of different nonlinear gain units are obtained according to different values of E(N).

Outputs of E(N) and the first nonlinear gain unit are two input signals of the first path. In the first path, an operation is performed on the two input signals, so as to obtain an output of the first path, where the operation is generally multiplication.

An output of the second nonlinear gain unit is an input of the second path, and an output of the second path is obtained according to the output of the second nonlinear gain unit.

FIG. 3 shows the feedback digital filter in the foregoing control apparatus. The feedback digital filter includes: a digital signal input end, a third path, a fourth path, a fifth path, a digital signal output end, and at least one nonlinear gain unit, where:

the digital signal input end is connected to the digital signal output end through the third path, the fourth path, and the fifth path separately; and

an input end of the nonlinear gain unit is connected to the digital signal input end, and an output end of the nonlinear gain unit is connected to the third path, the fourth path, and the fifth path separately, where each nonlinear gain unit is corresponding to one path. Specifically, the number of nonlinear gain unit is corresponding to the number of paths, and an output end of each nonlinear gain unit is correspondingly connected to one path. For example, an output end of a first nonlinear gain unit is correspondingly connected to the third path, an output end of a second nonlinear gain unit is correspondingly connected to the fourth path, and an output end of a third nonlinear gain unit is correspondingly connected to the fifth path.

In the foregoing feedback digital filter, the third path may be a proportional element P path, the fourth path may be an integral element I path, and the fifth path may be a differential element D path.

The following further describes the control apparatus of the embodiment of the present invention with reference to accompanying drawings and specific operating principles.

As shown in FIG. 1, a structure of the control apparatus includes:

an operational amplifier, which can amplify an error between a sample reference value and a measured output value;

an ADC (analog to digital converter), which includes a zero-order holder and a quantification element, samples an output of an operational amplifier whose preamplifier gain is adjustable, and quantifies the output to a digital signal value;

a PID feedforward unit (namely a feedforward digital filter), which has a structure similar to that of the feedback digital filter, but has no differential element D path and has only two nonlinear gain units; and achieves a feedforward function by coordinating the two nonlinear gain units, a proportional element P path, and an integral element I path in the PID feedforward unit;

a PID feedback unit (namely a feedback digital filter), which, as a digital filter of a ring circuit, generates a digital control signal, where the digital filter includes a nonlinear gain unit, which changes a coefficient of a current ring circuit according to a digital signal value obtained by quantifying the error between the sample reference value and the measured output value; and

a DPWM (digital pulse-width modulator), which, after sending the digital signal value of the ADC (analog to digital converter) to the feedback digital filter, converts the digital control signal generated by the feedback digital filter into a DPWM wave.

Both the feedback digital filter and the feedforward digital filter include the nonlinear gain unit, which changes the coefficient of the current ring circuit according to the error between the sample reference value and the measured output value and according to the quantified digital signal value.

A power source is commonly used to output constant voltage. As a regulator system, the power source usually encounters input disturbance and output disturbance. To stabilize output voltage, the disturbance needs to be suppressed, especially in scenarios with an input surge, transient voltage dips, and a relatively high dynamic change rate of load. The input disturbance is generally solved by means of feedforward, and load disturbance is generally solved by reducing output impedance by means of adding output capacitance or increasing bandwidth of a dynamic system, or by reducing dynamic output impedance by means of nonlinear control, where the bandwidth of a dynamic system can be increased by using a nonlinear gain unit. Generally, a digital controller (namely a control apparatus) includes more than one digital filter, with generally one or more redundant digital filters. In the present invention, without adding extra hardware, a feedforward function is achieved by using a redundant digital filter, thereby embracing a favorable application prospect.

### Embodiment 2

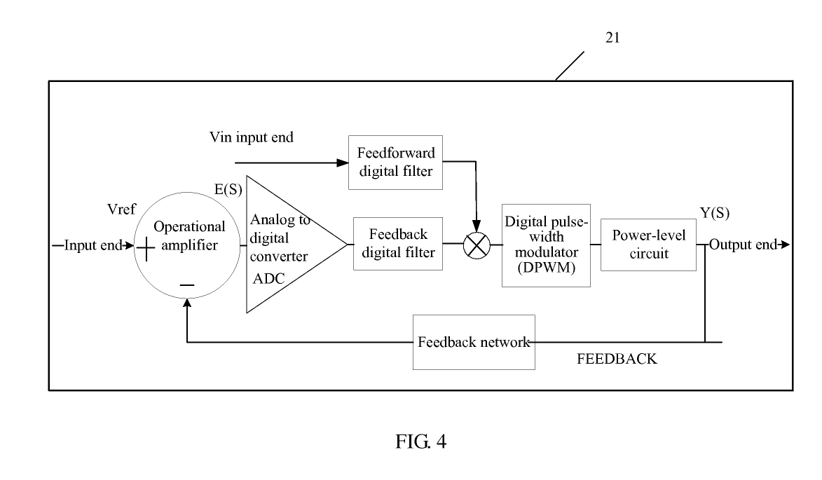

FIG. 4 shows a digital power supply device according to this embodiment of the present invention on a basis of the foregoing Embodiment 1. The digital power supply device includes an enclosure 21, and further includes a power circuit disposed in the enclosure 21, where the control apparatus described in the foregoing Embodiment 1 is used as a main control apparatus of the power circuit. A feedforward digital filter is disposed in the main control apparatus, which reduces the number of tables that are used to implement a reciprocal curve, and avoids problems of a long operational delay, a huge resource waste, and a poor feedforward effect.

The foregoing descriptions are merely exemplary implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A control apparatus applied to a digital power supply device, comprising:
an operational amplifier;
an analog to digital converter;
a feedback digital filter;
a digital pulse-width modulator;
a power-level circuit;
a feedforward digital filter; and
a feedback network, wherein:
an input end of the operational amplifier is a reference voltage input end, and an output end of the operational amplifier is connected to an input end of the analog to digital converter;
an output end of the analog to digital converter is connected to an input end of the feedback digital filter;
an output end of the feedback digital filter is connected to an input end of the digital pulse-width modulator;
an output end of the digital pulse-width modulator is connected to an input end of the power-level circuit;
a first output end of the power-level circuit is connected back to another input end of the operational amplifier through the feedback network, and a second output end of the power-level circuit generates an output directly; and
an input end of the feedforward digital filter is a voltage input end, and an output end of the feedforward digital filter is connected to the input end of the digital pulse-width modulator.

2. The control apparatus according to claim 1, wherein the feedforward digital filter comprises:
a digital signal input end, a first path, a second path, a digital signal output end, and two nonlinear gain units, wherein:
the digital signal input end is connected to an input end of the first path, and an output end of the first path is connected to the digital signal output end;
the digital signal input end is connected to an input end of the two nonlinear gain units, an output end of one nonlinear gain unit of the two nonlinear gain units is connected to the first path, and an output end of the other nonlinear gain unit is connected to the second path; and
an output end of the second path is connected to the digital signal output end.

3. The control apparatus according to claim 2, wherein the first path is a proportional element P path; and
the second path is an integral element I path.

4. The control apparatus according to claim 1, wherein the feedback digital filter comprises:
a digital signal input end, a third path, a fourth path, a fifth path, a digital signal output end, and at least one nonlinear gain unit, wherein:
the digital signal input end is connected to the output end through the third path, the fourth path, and the fifth path separately; and
an input end of the nonlinear gain unit is connected to the digital signal input end, and an output end of the nonlinear gain unit is connected to the third path, the fourth path, and the fifth path separately, wherein each nonlinear gain unit is corresponding to one path.

5. The control apparatus according to claim 4, wherein the third path is a proportional element P path;
the fourth path is an integral element I path; and
the fifth path is a differential element D path.

6. The control apparatus according to claim 4, wherein the number of nonlinear gain unit is corresponding to the number of paths, and an output end of each nonlinear gain unit is correspondingly connected to one path.

7. A digital power supply device, wherein the control apparatus according to claim 1 is used as a main control unit of the digital power supply device.

8. A digital power supply device comprising:
a control unit comprising the control apparatus according to claim 1.
